(19) United States
(12) Patent Application Publication
(10) Pub. No.: US 2023/0300885 A1
(43) Pub. Date: Sep. 21, 2023

(54) SIDELINK TRANSMISSION OVER UNLICENSED BANDS

(71) Applicant: MEDIATEK INC., Hsinchu (TW)

(72) Inventors: Jing-Wei CHEN, Hsinchu (TW); Tao CHEN, Beijing (CN); Lung-Sheng TSAI, Hsinchu (TW); Jun-Qiang CHENG, Beijing (CN); Yih-Shen CHEN, Hsinchu (TW)

(73) Assignee: MEDIATEK INC., Hsinchu (TW)

(21) Appl. No.: 18/180,527

(22) Filed: Mar. 8, 2023

(30) Foreign Application Priority Data
Mar. 15, 2022 (WO) PCT/CN2022/080912
Mar. 3, 2023 (CN) 202310200549.4

(51) Int. Cl. H04W 74/08; H04W 72/02

(52) U.S. Cl. CPC H04W 74/0816; H04W 72/02

(57) ABSTRACT

A method can include determining candidate sidelink resources by a user equipment (UE) for sidelink transmission on an unlicensed band from a sidelink resource selection window based on results of a sensing operation on the unlicensed band during a sidelink sensing window, selecting a sidelink resource from the candidate sidelink resources, performing a listen-before-talk (LBT) process on the unlicensed band to obtain a channel occupancy time (COT), and performing a sidelink transmission within the COT using the first sidelink resource. The selection of the sidelink resource can be based on an LBT time that is a predicted duration of a random backoff process of the first LBT process. Also, the first sidelink resource can be selected from the candidate sidelink resources without randomization.

### INCORPORATION BY REFERENCE

This present application claims the benefit of Chinese Application No. 202310200549.4, filed on Mar. 3, 2023, which claims the priority to International Application No. PCT/CN2022/080912, filed on Mar. 15, 2022. The disclosures of all the prior applications are incorporated herein by reference in their entirety.

### TECHNICAL FIELD

The present disclosure relates to wireless communications and specifically relates to sidelink communications over unlicensed bands.

### BACKGROUND

User demands on cellular system throughput are increasing every year. Cellular systems typically operate in a licensed spectrum, which is expensive, scarce, and bandwidth-limited. Therefore, one of the most promising approaches to increase the throughput of cellular networks is to utilize free unlicensed frequencies for data transmission.

### SUMMARY

Aspects of the disclosure provide a first method. The first method can include determining candidate sidelink resources by a user equipment (UE) for sidelink transmission on an unlicensed band from a sidelink resource selection window based on results of a sensing operation on the unlicensed band during a sidelink sensing window, selecting a first sidelink resource from the candidate sidelink resources, performing a first listen-before-talk (LBT) process on the unlicensed band to obtain a channel occupancy time (COT), and performing a sidelink transmission within the COT using the first sidelink resource. The selection of the first sidelink resource is based on an LBT time that is a predicted duration of a random backoff process of the first LBT process.

In an embodiment, in response to an LBT counter of the random backoff process being known, the LBT time can be determined to be a sum of a minimum LBT completion duration determined based on a value of the LBT counter and a duration of busy slots determined based on the results of the sensing operation. In response to the LBT counter of the random backoff process being unknown, the LBT time can be determine to be a sum of a maximum LBT completion duration determined based on a size of a contention window and the duration of the busy slots determined based on the results of the sensing operation.

In an embodiment, the selecting the first sidelink resource includes determining a predicted completion duration of the random backoff process to be a gap that is pre-configured or determined based on a system loading. In an embodiment, the selecting the first sidelink resource includes overbooking sidelink resources from the candidate sidelink resources. For example, a number of slots of overbooked sidelink resources is determined based on a pre-configuration or one of a HARQ-ACK feedback status, an LBT success probability, a channel loading status, a channel congestion control information, and a priority of a to-be-transmitted packet. In an embodiment, the selecting the first sidelink resource includes determining a predicted LBT completion duration of the random backoff process to be a sum of the LBT time and a gap. The gap can be configured as a function of the number of slots of overbooked sidelink resources.

In an example, the selection of the first sidelink resource from the candidate sidelink resources is triggered before the first LBT process. In an example, the selection of the first sidelink resource from the candidate sidelink resources is triggered before a completion of the first LBT process. In an example, the selection of the first sidelink resource from the candidate sidelink resources is triggered after the first LBT process.

In an embodiment, the selecting the first sidelink resource includes selecting multiple consecutive slots of sidelink resources from the candidate sidelink resources. In an embodiment, the selecting the first sidelink resource includes selecting two discontinuous sidelink resources from the candidate sidelink resources. The two discontinuous sidelink resources can include the first sidelink resource and a second sidelink resource. A timing difference between the two discontinuous sidelink resources is longer than the COT. An embodiment of the first method can further include performing a second LBT process to obtain a COT for a transmission using the second sidelink resource. The selection of the second sidelink resource can be based on an LBT time that is a predicted duration of a random backoff process of the second LBT process. In an embodiment, a timing difference between the two discontinuous sidelink resources is shorter than the COT. The embodiment of the first method can further include performing a short LBT process before a transmission using the second sidelink resource.

In an embodiment, multiple sidelink resources can be selected for a resource reservation interval (RRI). A length of the RRI can be larger than a sum of the LBT time, a gap that is pre-configured or determined based on a system loading, and a duration of overbooked sidelink resources corresponding each RRI. In an embodiment, the performing the LBT process includes, at an end of the random backoff process of the LBT process, performing a self-deferral operation followed by a short LBT sensing process before the sidelink transmission using the first sidelink resource, and obtaining the COT when a channel of the unlicensed band is idle during the short LBT sensing process.

Aspects of the disclosure provide a first apparatus. The first apparatus can include circuitry configured to determine candidate sidelink resources for sidelink transmission on an unlicensed band from a sidelink resource selection window based on results of a sensing operation on the unlicensed band during a sidelink sensing window, select a first sidelink resource from the candidate sidelink resources, perform a first LBT process on the unlicensed band to obtain a COT, and perform a sidelink transmission within the COT using the first sidelink resource. The selection of the first sidelink resource is based on an LBT time that is a predicted duration of a random backoff process of the first LBT process.

Aspects of the disclosure provide a first non-transitory computer-readable medium storing instructions. The instructions, when executed by a processor, can cause the processor to perform the first method.

Aspects of the disclosure provide a second method. The second method can include determining, by a UE, candidate sidelink resources for sidelink transmission on an unlicensed band from a sidelink resource selection window based on results of a sensing operation on the unlicensed band during a sidelink sensing window, selecting a first sidelink resource from the candidate sidelink resources without randomization, performing an LBT process on the unlicensed band to obtain a COT, and performing a sidelink transmission within the COT using the first sidelink resource selected from the candidate sidelink resources without randomization.

In an embodiment, a completion time of a random backoff process of the LBT process can be predicated. An earliest available resource can be selected from the candidate sidelink resources to be the first sidelink resource based on the completion time of the random backoff process of the LBT process. In an embodiment, after a completion of a random backoff process of the LBT process, an earliest available resource can be selected from the candidate sidelink resources without randomization. An embodiment of the second method can further include, in response to that a completion time of a random backoff process of the LBT process is later than a reservation time of the first sidelink resource, continuing the LBT process, predicting a completion time of a random backoff process of the LBT process, and reselecting an earliest available resource from a set of candidate sidelink resources without randomization to be a second sidelink resource based on the completion time of the random backoff process of the LBT process.

An embodiment of the second method can further include, in response to that a completion time of a random backoff process of the LBT process is later than a reservation time of the first sidelink resource, dropping the LBT process, and re-initiating another LBT process and selection of another sidelink resource.

In an embodiment, the performing the LBT process can include, at an end of a random backoff process of the LBT process, performing a self-deferral operation followed by a short LBT sensing process before the sidelink transmission using the first sidelink resource, and obtaining the COT when a channel of the unlicensed band is idle during the short LBT sending process. In an embodiment, the performing the LBT process can include obtaining the COT after a completion of a random backoff process of the LBT process, and performing a short LBT sensing process before the sidelink transmission using the first sidelink resource.

An embodiment of the second method can further include performing transmission on a cyclic prefix extension (CPE) starting position between a completion time of a random backoff process of the LBT process and a slot containing the first sidelink resource to occupy the unlicensed band. In an embodiment, multiple consecutive slots of sidelink resources are overbooked from the candidate sidelink resources. In an example, data corresponding a periodic traffic or an aperiodic traffic is received at a physical layer. The data can be transmitted by the sidelink transmission within the COT using the first sidelink resource. In an example, the LBT process is triggered when a channel access priority class of a to-be-transmitted packet is available.

Aspects of the disclosure provide a second apparatus. The second apparatus can include circuitry configured to determine candidate sidelink resources for sidelink transmission on an unlicensed band from a sidelink resource selection window based on results of a sensing operation on the unlicensed band during a sidelink sensing window, select a first sidelink resource from the candidate sidelink resources without randomization, perform an LBT process on the unlicensed band to obtain a COT, and perform a sidelink transmission within the COT using the first sidelink resource selected from the candidate sidelink resources without randomization.

Aspects of the disclosure provide a second non-transitory computer-readable medium storing instructions. The instructions, when executed by a processor, can cause the processor to perform the second method.

### BRIEF DESCRIPTION OF THE DRAWINGS

Various embodiments of this disclosure that are proposed as examples will be described in detail with reference to the following figures, wherein like numerals reference like elements, and wherein:

FIG. 1 shows an example of a Type 1 listen-before-talk (LBT) process 100 according to embodiments of the disclosure.

FIG. 2 shows an LBT duration 200 of a Type 1 LBT process followed by a channel occupancy time (COT) duration 213.

FIG. 3 shows an example of Mode 2 resource allocation according to some embodiments of the disclosure.

FIG. 4 shows an example where multiple COTs are acquired.

FIG. 5 shows an example of a SL-U channel access process 500 according to some embodiments.

FIG. 6 shows a self-deferral mechanism according to an embodiment of the disclosure.

FIG. 7 shows a case using resource overbooking mechanism.

FIG. 8 shows a SL-U channel access process 800 according to an embodiment of the disclosure.

FIG. 9 shows a SL-U channel access process 900 according to some embodiments of the disclosure.

FIG. 10 shows a SL-U channel access process 1000 according to an embodiment of the disclosure.

FIG. 11 shows another SL-U channel access process 1100 according to an embodiment of the disclosure.

FIG. 12 shows a SL-U channel access process 1200 according to an embodiment of the disclosure.

FIG. 13 shows a SL-U channel access process 1300 according to embodiments of the disclosure.

FIG. 14 shows another SL-U channel access process 1400 according to embodiments of the disclosure.

FIG. 15 shows an exemplary apparatus 1500 according to embodiments of the disclosure.

### DETAILED DESCRIPTION OF EMBODIMENTS

I. Sidelink Over Unlicensed Spectrum (SL-U)

A user equipment (UE) can perform sidelink (SL) transmission over an unlicensed band. For example, the UE can perform sidelink sensing, sidelink resource selection, and sidelink transmission while performing a channel access process, such as a listen-before-talk (LBT) process. The unlicensed band can already be occupied, for example, by Wi-Fi networks. The channel access process can satisfy the regulation requirements such that different radio access technologies (RATs) can fairly share the unlicensed band.

For example, a process of SL device to transmit on an unlicensed band can be performed as follows. The SL device (SL UE) obtains a SL sensing window configuration from a network. For example, during a sensing process, the SL device senses and decodes SL control information (SCI) on physical sidelink control channel (PSCCH) resources within a SL sensing window. Based on sensing results from the sensing process, the SL device can determine a candidate sidelink resource set. The SL device performs SL resource selection on the candidate sidelink resource set to select and reserve transmission opportunities (or transmission resources). The SL device can acquire one or more channel occupancy times (COTs) by triggering one or more LBT process. The SL device transmits on the selected/reserved transmission opportunities within the COTs.

Operation methods for SL devices to transmit on an unlicensed band are disclosed. In the operation methods, regulation requirements for operating on an unlicensed band (including LBT process to acquire COT) are satisfied, while SL resource allocation rules are respected. The techniques disclosed herein address the following issues: (i) LBT category and process adopted by a SL device to access an unlicensed-band channel; and (ii) sidelink over unlicensed spectrum (SL-U) operation combining an LBT process and a SL resource allocation scheme. The SL resource allocation scheme can be similar to, for example, sidelink resource allocation Mode 2 specified in the standard specification developed by the 3rd Generation Partnership Project (3GPP). In the disclosure, examples of the LBT category and the corresponding channel access process are described. Examples of a baseline operation of a SL device accessing an unlicensed band channel based on an LBT process and SL resource allocation Mode 2 are described.

In some embodiments, the LBT category and process adopted by SL devices can be similar to New Radio (NR) uplink (UL) shared spectrum channel access process Type 1 or Type 2. In some embodiments, SL transmission based on LBT process can have two scenarios:
(Scenario 1) Obtain an initial COT for transmission.
(Scenario 2) Share COT from other SL devices.

For example, in an Out-of-COT operation, an initial COT can be obtained for transmission. SL devices can apply the Out-of-COT LBT to obtain an initial COT. For example, a Type-1 LBT (CAT4 LBT) can be applied. The Type 1 LBT can be an LBT process with a random back-off and a variable extended clear-channel assessment (CCA) period. For example, the initial value of a count-down timer (or counter) used in the random back-off can be randomly drawn from a variable-sized contention window. The size of the contention window can vary based on channel dynamics.

For example, in an In-COT operation, a SL UE can share a COT from other SL devices, or share a COT for multiple SL transmissions. SL devices can apply an In-COT LBT to share a COT. In some examples, the In-COT LBT type can be determined up to an indication of a COT owner. In some examples, the In-COT LBT type can be determined to be a Type 1 LBT (i.e., with a random backoff). In some examples, the In-COT LBT type can be determined up to the transmission gap. For example, Type 2A/2B/2C LBT (i.e., without random backoff) can be used.

II. Channel Access Process Based on LBT Mechanism

LBT-based channel access process (LBT process) and related parameters are introduced below according to embodiments of the disclosure.

In the present disclosure, a channel refers to a shared spectrum (such as an unlicensed band) including radio resources on which a channel access process is performed. A channel access process (such as an LBT process) can be based on sensing that evaluates the availability of a channel for performing transmissions. The basic unit for sensing can be a sensing slot Tₛₗ. For example, a sensing slot can have a duration Tₛₗ=9 μs. The sensing slot duration Tₛₗ is considered to be idle if a UE senses the channel during the sensing slot duration, and determines that the detected power, for example, for at least 4 μs within the sensing slot duration is less than an energy detection threshold X_{Thresh}. Otherwise, the sensing slot duration Tₛₗ is considered to be busy.

A channel occupancy refers to transmission(s) on channel(s) by UE(s) after performing the corresponding channel access processes. A Channel Occupancy Time (COT) refers to the total time for which a UE and any UE sharing the channel occupancy perform transmission(s) on a channel after the corresponding channel access processes. In some examples, for determining a COT, if a transmission gap is less than or equal to, for example, 25 μs, the gap duration is counted in the channel occupancy time. A channel occupancy time can be shared for transmission between UE(s).

In some examples, a SL transmission burst is can be a set of transmissions from a UE without any gaps greater than a predefined threshold, such as 16 μs. Transmissions from a UE separated by a gap of more than the predefined threshold can be considered as separate SL transmission bursts. A UE can transmit transmission(s) after a gap within a SL transmission burst without sensing the corresponding channel(s) for availability.

In some examples, SL transmission(s) are performed according to one of Type 1 or Type 2 SL channel access processes (Type 1 or Type 2 SL LBT processes). For Type 1 SL channel access process (Type 1 LBT), the time duration spanned by the sensing slots that are sensed to be idle before a SL transmission(s) is random. In some examples, a SL UE may perform Type 1 channel access process as follows. The SL UE may first sense the channel to be idle during the sensing slot durations of a defer duration T_{d}. Then, the SL UE may perform the following steps: 1) set N=Nᵢₙᵢₜ, where Nᵢₙᵢₜ is a random number uniformly distributed between 0 and CWₚ (a contention window), and go to step 4; 2) if N>0 and the UE chooses to decrement the counter, set N=N−1; 3) sense the channel for an additional sensing slot duration, and if the additional sensing slot duration is idle, go to step 4; else, go to step 5; 4) if N=0, stop; else, go to step 2. 5) sense the channel until either a busy sensing slot is detected within an additional defer duration T_{d} or all the sensing slots of the additional defer duration T_{d} are detected to be idle; 6) if the channel is sensed to be idle during all the sensing slot durations of the additional defer duration T_{d}, go to step 4; else, go to step 5.

In some examples, the SL UE may transmit a transmission on the channel, if the channel is sensed to be idle at least in a sensing slot duration Tₛₗ when the UE is ready to transmit the transmission and if the channel has been sensed to be idle during all the sensing slot durations of a defer duration T_{d} immediately before the transmission. In some examples, the defer duration T_{d} includes duration T_{f}=16 μs immediately followed by mₚ consecutive sensing slot durations. For example, each sensing slot duration is Tₛₗ=9 μs. For example, T_{f}=16 μs T_{f} includes an idle sensing slot duration Tₛₗ at start of T_{f}.

In some examples, the contention window size CWₚ can be selected from a range, such as CW_{min,p}<CWₚ CW_{max,p}. For example, CWₚ adjustment can be based on a channel loading status. The lower and upper limits of the contention window size, CW_{min,p} and CW_{max,p}, can be chosen before step 1 of the process above. The parameters mₚ, CW_{min,p}, and CW_{max,p} can be determined based on a channel access priority class (CAPC) p associated with the current SL transmission(s). A COT of the current SL transmission(s) can also be determined based on the CAPC. An example of SL LBT process parameters associated with CAPC is shown in Table 1.

TABLE 1

| Channel | | | | | |
|---|---|---|---|---|---|
| Access | | | | | |
| Priority Class | | | | | |
| (p) | mₚ | CW_{min, p} | CW_{max, p} | T_{maximum cot, p} | allowed CWₚ sizes |
| 1 | 2 | 3 | 7 | 2 ms | {3, 7} |
| 2 | 2 | 7 | 15 | 4 ms | {7, 15} |
| 3 | 3 | 15 | 1023 | 6 ms or 10 ms | {15, 31, 63, 127, 255, 511, 1023} |
| 4 | 7 | 15 | 1023 | 6 ms or 10 ms | {15, 31, 63, 127, 255, 511, 1023} |

For Type 2 SL channel access process (Type 2 LBT process), the time duration spanned by the sensing slots that are sensed to be idle before a SL transmission(s) can be deterministic. In some examples, for a Type 2A SL channel access process (Type 2A SL LBT process), a SL UE may transmit the transmission immediately after sensing the channel to be idle, for example, for at least a sensing interval T_{short_ul}=25 μs. T_{short_ul} can include a duration T_{f}=16 μs immediately followed by one sensing slot. T_{f} includes a sensing slot at start of T_{f}. The channel is considered to be idle for T_{short_ul} if both sensing slots of T_{short_ul} are sensed to be idle.

In some examples, for Type 2B SL channel access process (Type 2B SL LBT process), a UE may transmit the transmission immediately after sensing the channel to be idle within, for example, a duration of T_{f}=16 μs. T_{f} includes a sensing slot that occurs within the last 9 us of T_{f}. The channel is considered to be idle within the duration T_{f} if the channel is sensed to be idle for total of at least 5 us with at least 4 us of sensing occurring in the sensing slot, for example. In some examples, for Type 2C SL channel access process (Type 2C SL LBT process), a UE does not sense the channel before the transmission. The duration of the corresponding UL transmission is, for example, at most 584 us.

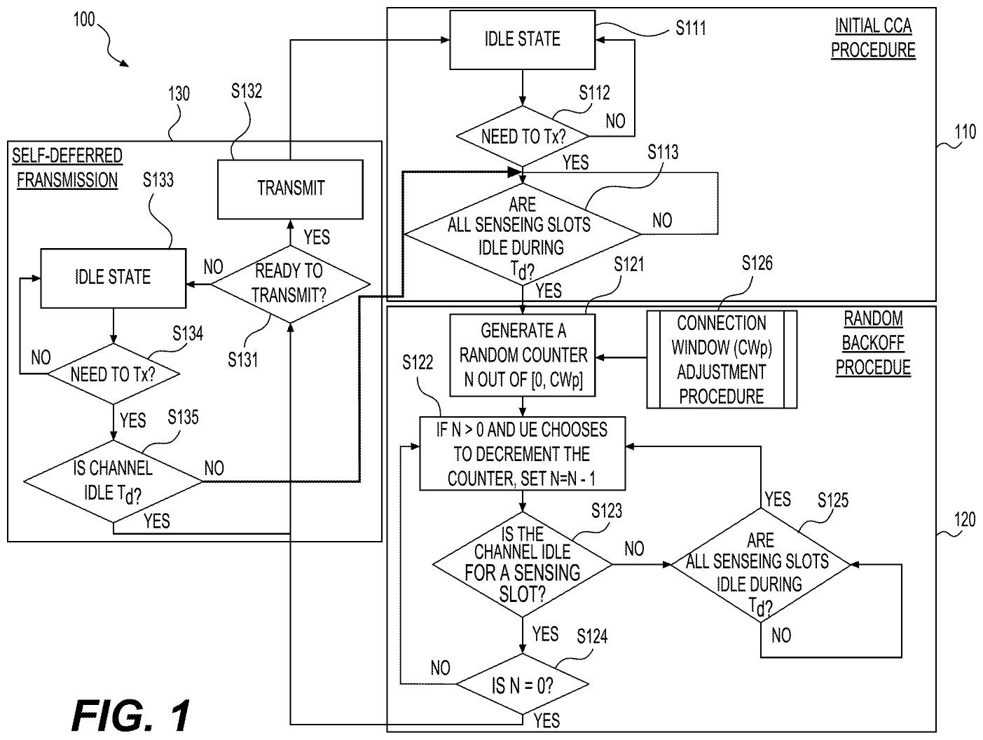

FIG. 1 shows an example of a Type 1 LBT (CAT4 LBT) process 100 according to embodiments of the disclosure. The process 100 can include 3 individual parts forming a loop: an initial clear channel assessment (CCA) process (or procedure) 110, a random backoff process (or procedure) 120, and a self-deferred transmission 130. A UE can perform the process 100 to access a sidelink channel on an unlicensed band. The process 100 can start from S111.

At S111, the UE can operate in an idle state. At S112, whether a transmission is to be performed is determined. If so, the process 100 proceeds to S113. Otherwise, the process 100 returns to S111. At S113, the UE sense whether the channel is idle during the sensing slot durations of a defer duration T_{d}. If the channel is idle for all the sensing slots, the process 100 proceeds to S121 and enters the random backoff process 120. Otherwise, the process 100 repeats the operations of S113.

At S121, the UE generates a random counter value N out of a contention window between 0 and CWₚ. A contention window adjustment process (or procedure) S126 may be performed at S121 based on a channel loading status. At S122, the UE may decrement the counter by 1. At S123, the UE performs a sensing of the channel for a sensing slot. If the channel is idle for the sensing slot, the process 100 proceeds to S124. Otherwise, the process 100 proceeds to S125. At S125, the UE repeatedly performs channel sensing during a differ duration T_{d} until the channel is idle. Then, the process 100 returns to S122. At S124, if the counter value equals 0, the process proceeds to S131 and enters the self-deferred transmission 130. Otherwise, the process returns to S122.

At S131, whether the UE is ready to transmit a transmission is determined. If so, the process 100 proceeds to S132—. Otherwise, the process 100 proceeds to S133. At S133, the UE can operate in an idle state. At S114, whether a transmission is to be performed is determined. If so, the process 100 proceeds to S135. Otherwise, the process 100 returns to S133. At S135, the UE senses the channel during sensing slots of a defer duration T_{d}. If the channel is idle during the defer duration T_{d}, the process 100 proceeds to S131. Otherwise, the process returns to S113.

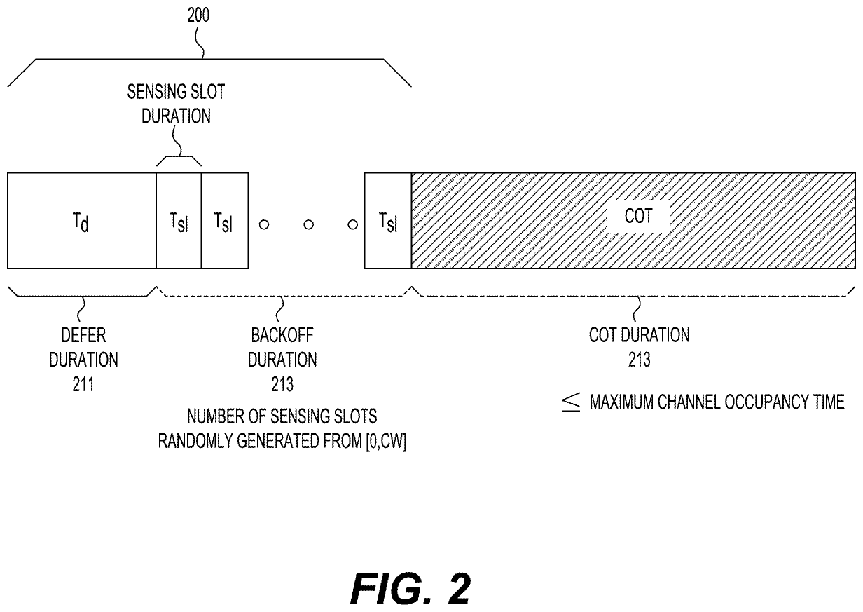

FIG. 2 shows an LBT duration 200 of a Type 1 LBT process followed by a COT duration 213. As shown, the LBT duration can include 2 portions: a defer duration 211 and a backoff duration 212. The variables to determine LBT duration 200 and COT duration 213 can be configured according to a priority class. For example, the backoff duration 212 can determined based on a number of sensing slots randomly generated from a contention window (CW). The size of the contention window can be determined based on a priority class of the related SL transmission (e.g., CAPC). The COT duration 213 is bounded by a maximum channel occupancy time T_{maximum cot}. The maximum channel occupancy time T_{maximum cot} can also be determined based on the priority class of the related SL transmission (e.g., CAPC).

In the FIG. 2 example, the minimum length of time taken by an LBT process can be the summation of the defer duration 211 (T_{d}) and the backoff duration 212 (sensing slots duration). The number of sensing slots, denoted by N, can be randomly rolled between 0 and a CW size. Accordingly, in some examples, an LBT duration (or LBT time) can be expressed as follows,

LBT duration (LBT time)=Td+Tsl*N.

III. Sidelink Mode 2 Resource Allocation

The process and parameters of SL channel sensing and resource selection in resource allocation Mode 2 are introduced below according to embodiments of the disclosure.

In some examples, physical sidelink control channel (PSCCH) and physical sidelink shared channel (PSSCH) resources can be defined within a resource pool for the respective channel. A SL UE can make resource selections based on sensing within the resource pool. A resource pool can be divided into sub-channels in the frequency domain. Resource allocation, sensing, and resource selection can be performed in units of a sub-channel. There can be two SL resource allocation modes: Mode 1 and Mode 2 in various embodiments. Mode 1 can be used for resource allocation by a base station (BS). Mode 2 can be for UE autonomous resource selection (without involvement of a BS).

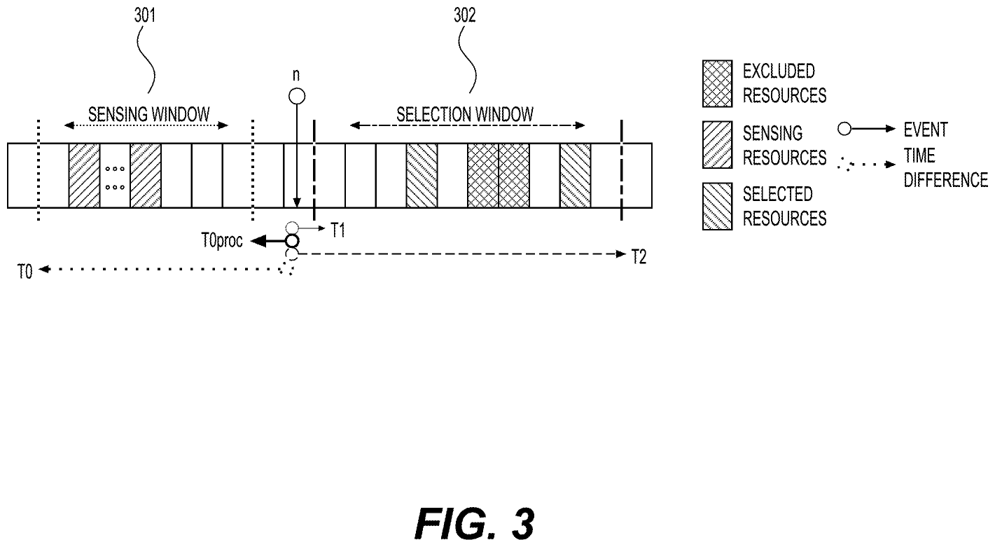

FIG. 3 shows an example of Mode 2 resource allocation according to some embodiments of the disclosure. A UE performs sensing within a (pre-)configured resource pool to know which resources are not in use by other UEs with higher-priority traffic. Accordingly, the UE can select an appropriate amount of such resources for transmissions. The UE can transmit and retransmit a certain number of times on the selected resources.

For example, resource reservation information can be carried in a sidelink control information (SCI) (such as a first stage SCI) scheduling a current transport block. The SCI may be carried in a PSCCH. A sensing UE can monitor a sensing window 301 to decode other UEs' PSCCHs to obtain which resources have been reserved. The sensing UE can also measure SL reference signal received power (SL-RSRP) in the slots of the sensing window 301. In this way, the sensing UE can collect the sensing information including reserved resources and SL-RSRP measurements associated with the sending window 301. For example, a traffic arrival or a re-selection trigger may takes place in slot n. The sensing window 301 can start at slot [n-T0] in the past and finishes at slot [n-T0proc], shortly before slot n. For example, the sensing window 301 can be 1100 ms or 100 ms wide. The 100 ms option can be used for aperiodic traffic. The 1100 ms option can be used for periodic traffic.

The sensing UE can then select resources for (re-)transmission(s) from within a selection window 302. For example, the selection window 302 can start at slot [n+T1], shortly after the trigger for (re-)selection of resources, and finish at slot [n+T2]. T2 cannot be longer than the remaining latency budget of the packet due to be transmitted. Reserved resources in the selection window with SL-RSRP above a threshold can be excluded from being candidates by the sensing UE. The threshold can be set according to the priorities of the traffic of the sensing and transmitting UE. For example, a higher-priority transmission from a sensing UE can occupy resources that are reserved by a transmitting UE with sufficiently low SL-RSRP and sufficiently lower-priority traffic.

In some examples, the UE can select an appropriate amount of resources randomly from this non-excluded set. The resources selected in general are not periodic. Up to three resources can be indicated in each SCI transmission. Those resources can each be independently located in time and frequency. In some cases, the indicated resources can be reserved for semi-persistent transmission of another transport block(s). In some examples, shortly before transmitting in a reserved resource, a sensing UE re-evaluates the set of resources from which it can select, to check whether its intended transmission is still suitable. For example, late-arriving SCIs may indicate an aperiodic higher-priority service starting to transmit after the end of the original sensing window. If the reserved resources would not be part of the set for selection, then new resources are selected from the updated resource selection window.

IV. SL-U Operation (Baseline) Design

1. Problems and Key Issues

In various embodiments, the SL-U operation can be designed to address the scenario where a SL device acquires an initial COT for transmission and obtains transmission resource by SL resource allocation Mode 2. The 3GPP TS 38.214 provide further examples of SL resource allocation Mode 2. For SL-U operation, two expected behaviors can be:
SL device performs Type-1 LBT (LBT CAT4) to get COT for transmission
SL device follows SL resource allocation Mode 2 to perform SL sensing and resource selection

In some embodiments, to combine SL resource allocation Mode 2 and LBT process together, the following 4 problems are identified.

(1) Time uncertainty of COT acquisition. COT acquisition time uncertainty complicates SL resource selection: LBT CAT4 process includes a back-off counter N randomly generated from a CW size. The LBT count-down sensing slot numbers are unknown before the counter N is rolled. In addition, even if the value of counter N is obtained, the precise timing for count-down-to-zero remains unknown due to various RAT devices' transmissions on unlicensed band. As the result, there exists time uncertainty to finish LBT process for COT acquisition. The uncertainty complicates a SL device to pre-select resources.

(2) Transmission opportunity constrained by SL resource selection principles. SL transmission opportunity constraint can nullify LBT process. Specifically, for SL-U operation, a device cannot initiate a transmission right after a successful COT acquisition by LBT operation. Following SL resource allocation Mode 2, a device can only transmit onto its selected/reserved resource. There exists a time gap between the COT acquisition and the transmission slot of a reserved resource, leading to a risk that the COT opportunity may be intercepted by other devices. When the gap is large enough (for example, longer than the COT duration), there would be no available SL resource within the COT.

(3) Timing relevance of LBT process and SL resource selection. Triggering LBT and SL resource selection without a well-planned ordering may result in misalignment of COT acquisition and SL transmission slot, leading to LBT failure or SL resource re-selection. Adjustment of timing to kickoff SL resource selection and LBT process is possible. It is essential to find reasonable order to align LBT countdown completion slot and SL transmission slot to improve time efficiency and transmission success probability of SL-U operation.

(4) Randomization for collision avoidance. Combining LBT and SL resource selection may lead to misalignment of COT acquisition and SL transmission slot. Unlicensed-band operation or sidelink operation is of a distributed nature. To avoid unnecessary collisions and retransmissions, Tx randomization mechanism is desired. LBT process with a random backoff is employed for unlicensed band operation while resource selection randomization (i.e., Mode 2) is employed for SL operation. By considering the design consideration from 1 to 3, Tx randomization method can be further evaluated for SL-U operation. Combining directly the two randomization processes above can be optional.

The following key issues are targeted in various embodiments of the disclosure:
Increase the probability of COT acquisition success before a device's selected resource
Reduce time gap between LBT completion and the selected SL transmission slot
Solve the problem when COT acquisition time exceeds last SL transmission slot
Determine the necessity of 2 randomization processes

Based on the above-mentioned design considerations, the SL-U operation is designed to combine LBT process and SL resource allocation Mode 2 process. The baseline process targets to support:
periodic and aperiodic traffics
SL resource allocation Mode 2 to reserve continuous/discontinuous resources on time domain. Accordingly, single COT corresponding to continuous resources or multiple COT corresponding to discontinuous resources can be acquired within a SL resource selection window.

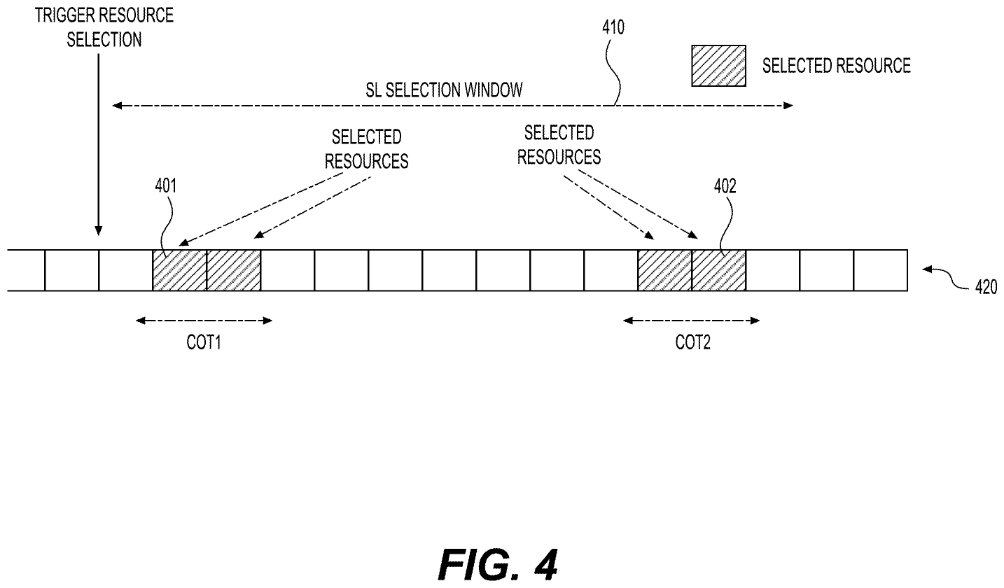

FIG. 4 shows an example where multiple COTs are acquired. A sequence of slots 420 is shown to represent timings of a sidelink. A first set of SL resources 401 and a second set of SL resources 402 are selected from a SL selection window 410. Both the first set of SL resources 401 and the second set of SL resources 402 can each include resources distributed in two consecutive slots. The first set of SL resources 401 and the second set of SL resources 402 can be covered by two separate COTs, COT1 and COT2, respectively.

2. Solutions

(1) Solutions for Timing Uncertainty to Acquire COT by LBT Process

To accommodate the COT acquisition timing uncertainty, in some embodiments, SL-U resource selection operation considers the followings:
Forecasting possible LBT completion time to ensure that the selected resources are likely to the actual transmission
Avoiding the missing of transmission opportunity; i.e., COT acquisition completion is later than the first selected resource

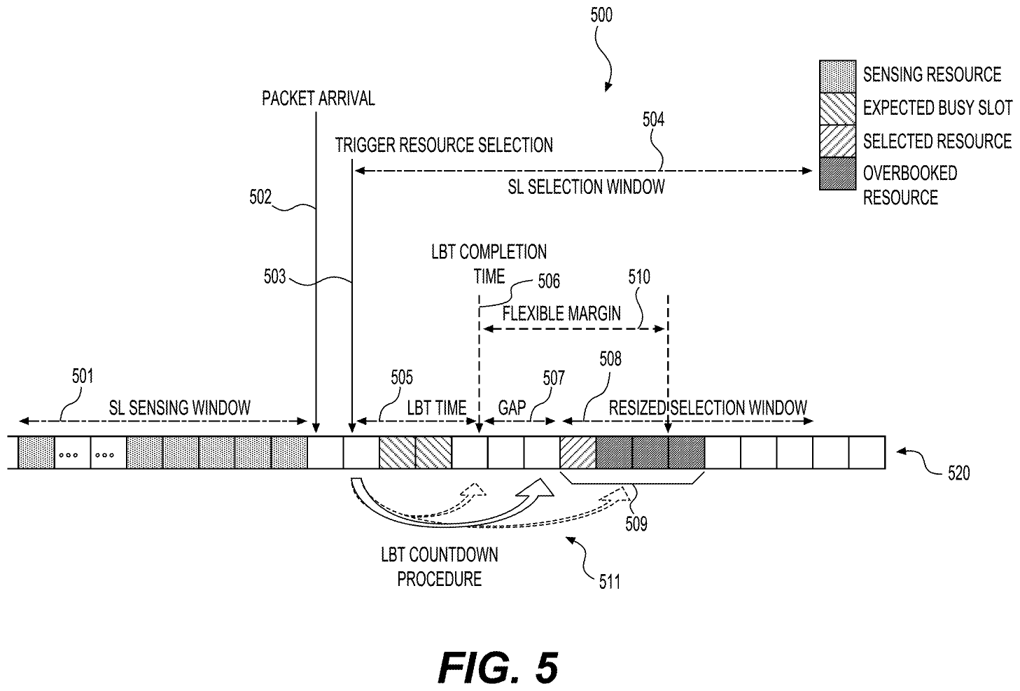

FIG. 5 shows an example of a SL-U channel access process 500 according to some embodiments. The SL-U channel access process 500 can be based on predictions of an LBT time and a gap and based on a resource overbooking scheme. A sequence of slots 520 is shown in FIG. 5 to represent the timings of various events. For example, each slot can be a resource allocation unit in a SL resource pool in time domain. Each slot can be partitioned from a subframe or frame representing timings in a wireless communication network, such as an NR or Long Term Evolution (LTE) network specified by 3GPP standards.

For example, an event of packet arrival 502 at a SL UE can take place first. A SL resource selection 503 can be triggered after the packet arrival 502. The SL resource selection 503 can be based on sensing information (e.g., reserved resources and SL-RSRP) collected from a SL sending window 501. An initial SL selection window 504 can start shortly after the resource selection 503 being triggered.

When performing the SL resource selection 503, the SL UE can forecast an LBT minimum completion duration (LBT time) 505. The UE can also forecast a gap 507 that is a flexible time margin to tolerant COT acquisition time uncertainty. A resized selection window 508 can be determined by deducting the LBT time 505 and the gap 507 from the SL selection window 504. Candidate resources can be determined from within the resized selection window 508. Further, to increase transmission opportunity, resources 509 including overbooked resources can be selected from the candidate resources. One merit of the process 500 is that the selected resources 509 have a high chance for actually being used for transmission while a resource selection process and an LBT countdown process (or procedure) 511 run in parallel.

As shown, the LBT countdown process (or referred to as LBT backoff process) 511 may be completed within a flexible margin 510 starting from a forecasted LBT completion time 506. It is noted that while the resources 509 (including 4 slots) are shown to include selected resources (the first slot) and overbooked resources (the last 3 slots) in FIG. 5, the resources 509 themselves can be referred to as selected resources or overbooked resources depending on the context of the discussions in this disclosure. For example, in the disclosure, “selected resources” means the respect resources are selected from SL candidate resources; “overbooked resources” means the respect resources include resources more than the resources needed for transmission of a data packet.

In various embodiments, the LBT completion duration (LBT time) forecasting can be performed in various ways. In a first case (Case 1), the LBT time can be predicted when the LBT counter N is known. Once the LBT counter N is rolled, a minimum LBT completion duration is known with the assumption that all sensing slots are idle. With SL sensing, the reservation slot information from other SL devices is obtained. The SL UE can accordingly determine which sensing slots are busy. The LBT countdown duration time can be extended by the busy slot occupation. Therefore, the LBT time can be calculated by adding up the minimum LBT completion duration and the busy slot duration obtained from the SL sensing.

In a second case (Case 2), the LBT time can be predicted when the LBT counter N is unknown. If the LBT counter N is unknown, then the contention window (CW) size, which is the upper bound of LBT counter N value, can be applied for calculation. A maximum LBT completion duration (without busy sensing slots) can be determined to be equal to the CW size. Again, the LBT time is calculated by adding up the maximum LBT completion duration and busy slots forecasted based on SL sensing results (sensing information).

In some embodiments, when forecasting busy slots within the LBT countdown time (LBT backoff duration), a transferring of SL-RSRP of SL sensing information to received signal strength indication (RSSI) of LBT is performed. Accordingly, the slot energy level against an LBT energy threshold can be determined for determining busy sensing slots. A more precise LBT time can thus be determined. Generally, an LBT process uses RSSI for sensing while SL resource allocation uses RSRP for sensing. SL sensing results can be used to get the reserved transmission of other SL devices within a selection window. Then transferring measured RSRP of reservation devices to RSSI on future reservation slots helps to forecast the LBT time.

In various embodiments, the flexible margin (gap) can be determined in various ways. Considering that non-SL devices may coexist in unlicensed band spectrum, a flexible time margin can be reserved in case of unknown busy slots. By inserting the gap, a high possibility of LBT completion before the end of the period of LBT time plus the gap is ensured. The gap can be determined by (pre-)configuration or up to system loading. For example, by configuration, parameters of gaps can be signaled from a network. By pre-configuration, parameters of gaps can be stored in a non-volatile memory of the SL UE.

In various embodiments, various ways of excessing resource selection (resource overbooking) can be employed. The overbooked SL resources can be consecutive or non-consecutive in time domain. For example, the overbooked SL resources can exist in multiple consecutive slots. Resource overbooking can be applied to prolong a SL transmission opportunity to cope with the following cases:
LBT countdown duration exceeds the expected LBT completion time (for example, the end of the period of the LBT time plus the gap)
Not enough slots are reserved for LBT completion before first transmission slots

Another benefit of resource overbooking is that during own reservation slots, it is unlikely that other SL devices perform transmission. Therefore, idle LBT sensing slots are ensured and LBT counter can be counted down. For example, the number of overbooked resources can be determined dynamically according to the HARQ-ACK feedback status and/or LBT success probability and/or channel loading status and/or channel congestion control information, and/or the layer 1 (physical layer) priority. The number of overbooked resources in the context of discussing duration of the overbooked resources refers to a number of slots of the overbooked resources in the present disclosure.

In some examples, a combination of LBT time and/or gap and/or resource overbooking can be employed. In an embodiment, the SL-U operation can be initiated by integrating all the 3 elements together. In an embodiment, gap or resource overbooking may be skipped. In another embodiment, the gap can be configured as a function of the overbooking number of slots. An example of such function is shown below

Gap (slots)+Overbooking number of slots=k, (2)

where k is the integer value determined by (pre-)configuration or up to system loading. For example, the overbooking number of slots can be determined first, for example, according to positive acknowledgement/negative acknowledgement (ACK/NACK) feedback, then the gap can be determined secondly according to overbooking status.

(2) Solutions for Transmission Opportunity Constrained by SL Resource Selection Principle

SL transmission opportunity takes place on the selected resources or slots. Transmission opportunity constraints can lead to the expiration of a COT acquired from an LBT process. To align the timing of COT acquisition and SL transmission slots, various mechanisms can be adopted based on SL resource selection strategy and LBT completion time.

a. Self-Deferral Period

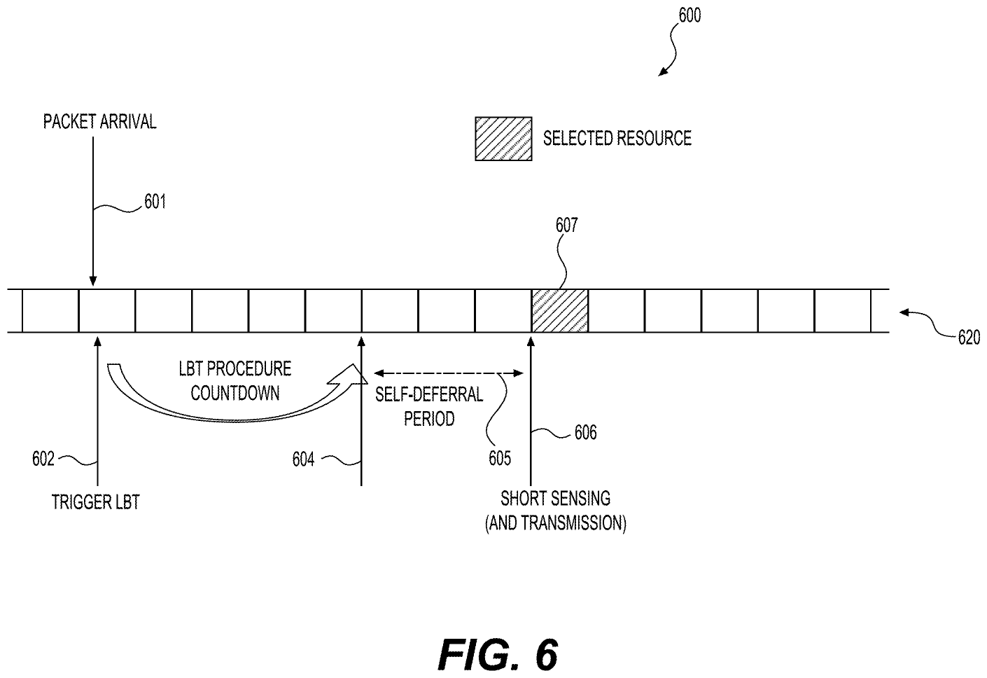

FIG. 6 shows a self-deferral mechanism according to an embodiment of the disclosure. A sequence of slots 620 is shown. A packet arrival 601 can first take place followed by a trigger 602 of an LBT process. After a completion 604 of an LBT countdown, an LBT self-deferral period 605 is initiated until the earliest SL transmission slot 607. Upon SL transmission slot 607, a short LBT (Type 2 LBT or LBT CAT2) sensing 606 is performed accordingly. If the sensing result is channel idle, then a COT acquisition can be executed directly. A data transmission opportunity becomes available. If the sensing result is channel busy, then another round of LBT and SL resource selection process can be triggered again.

b. In-COT LBT

In some embodiments, at an LBT completion time, if the earliest and latest SL transmission slots are within the duration before the timing of LBT completion time plus COT length, then a SL device can acquire a COT immediately after the LBT completion and perform a short LBT in-COT sensing right before the SL transmission slot.

c. Slot Boundary Alignment

In some embodiments, when the timing difference between LBT completion time and SL transmission slot is less than a certain duration (such as one or more orthogonal frequency-division multiplex (OFDM) symbols), then the cyclic prefix (CP) extension (CPE) and timing advance (TA) can be used to align the slot boundary and acquire COT for transmission. For example, a COT can be acquired at the LBT completion time by a SL UE on a channel. The SL UE can transmit a CP signal before a slot boundary of a SL transmission slot to occupy the channel. For example, the SL UE can transmit a CP signal on a CPE starting position before a slot boundary of a SL transmission slot to occupy the channel.

d. Overbooking

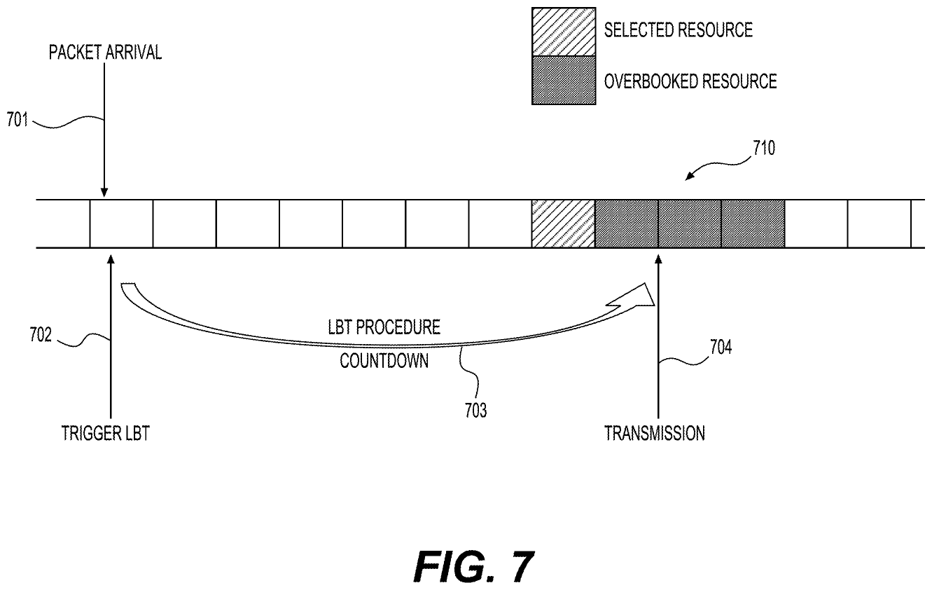

To avoid COT acquisition failure caused by long self-deferral period and additional short LBT sensing, resource overbooking can be another solution to align COT acquisition timing and SL transmission slots. FIG. 7 shows the case using resource overbooking mechanism. An LBT trigger 702 takes place after a packet arrival 701. An LBT count down process (or procedure) 703 is completed at a timing 704 within the overbooking time slots 710. A COT can be immediately occupied at the timing 704 for SL transmission.

(3) Solutions for Timing Relevance

In various embodiments, the mechanisms disclosed herein allow SL resource selection to be triggered before or after LBT completion. Thus, the timing order of SL resource selection and LBT operation is flexible. For different use cases, different triggering timings of SL resource selection and LBT operation can be combined with the solutions disclosed herein. In some examples, there exist 3 basic use cases for SL resource selection:
Selection of continuous resources
Selection of discontinuous resources
Selection of resources with resource reservation interval (RRI) periodic reservation. For example, the periodicity of SL transmissions can be defined by an RRI. An RRI can be equal to 0 ms, 2 ms, 5 ms, 20 ms, 100 ms, 1000 ms, and the like in an example.

Based on these 3 basic use cases, some SL resource selection Mode 2 scenarios can be illustrated. For example, if a SL device wants to select resource sets for new transmission and retransmission (i.e., HARQ-like operations), then it can perform a selection of discontinuous resources, or several selections of continuous resources in a row in time domain. There is benefit of a discontinuous resources selection over continuous resources selection. Since multiple resource sets are selected at early timing, the second resource sets can be reserved in the SCI of first transmitted resource set.

(a) Selection of Continuous Resources

In some examples, the timing to trigger selection of continuous resources can be flexible. If a device triggers SL resource selection process before LBT completion, then the above-described techniques of LBT time, gap and overbooking resources can provides forecasting LBT completion time and flexible guard margin to ensure LBT can be completed before selected transmission slot.

(b) Selection of Discontinuous Resources

Case 1: Timing Difference Between 2 Resource Sets is Longer than a COT Length

In some embodiments, when timing difference between 2 selected resources sets is larger than a COT length, then multiple LBT processes can be performed to obtain multiple COTs for discontinuous transmissions.

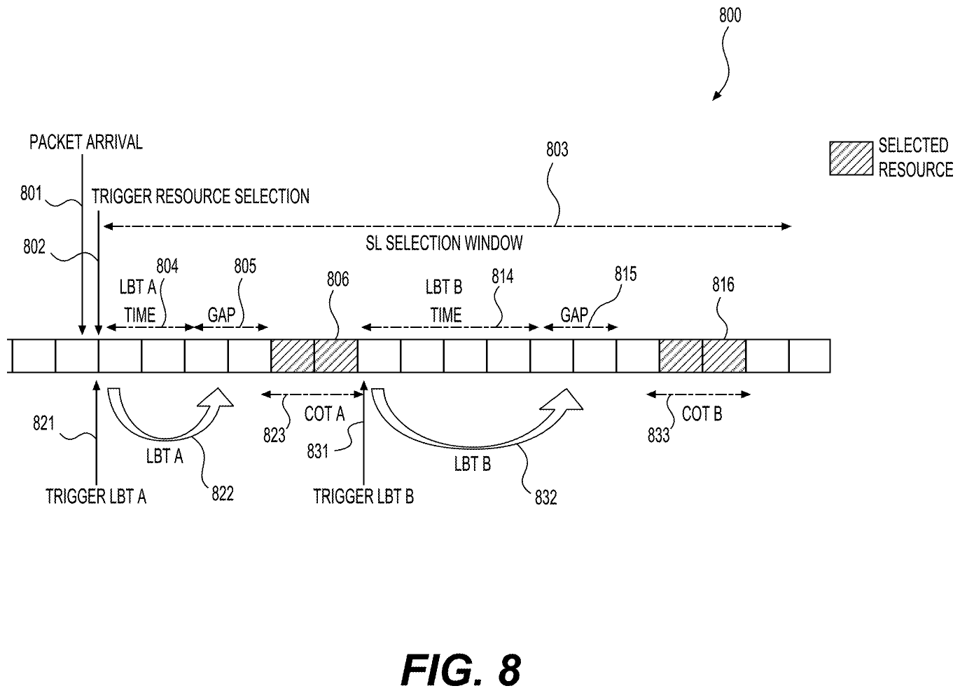

FIG. 8 shows a SL-U channel access process 800 according to an embodiment of the disclosure. The timing relationship between resource selection and LBT operations are illustrated. In the process 800, SL resource allocation Mode 2 is employed to reserve discontinuous resources on time domain. Multiple COT acquisitions are performed within a SL selection window 803.

After a packet arrival 801, a resource selection 802 is triggered before any LBT process completion. Discontinuous resources 806 and 816 can be reserved within selection window 803. The resource reservation of the resources 806 can be based on a first forecast of a first LBT time 804 and a first gap 805. The resource reservation of the resources 816 can be based on a second forecast of a second LBT time 814 and a second gap 815. The resources 806 or 816 can be a single slot resource, or multiple consecutive slot resources. Meanwhile, a first LBT process A 822 can be triggered at a time 821 to acquire a COT A 823. Once transmission scheduled within COT A 823 is done, a second LBT process B 832 can be performed at a time 831 to acquire a COT B 833. With LBT time forecasting calculation, the COT acquisitions are highly possible to be completed before SL transmission slots.

Case 2: Timing Difference Between 2 Resource Sets is Shorter than a COT Length

In some examples, when timing difference between 2 resources sets is smaller than a COT length, one LBT process can be triggered to obtain a COT that covers the transmissions of 2 resource sets. To obtain an initial COT, a Type 1 (LBT CAT4) process can be used. Upon COT acquisition, transmission on a first reserved resource set can be triggered. During the COT, if another transmission on a second reserved resource set is required, then a short LBT (e.g., Type 2A/Type2B/Type 2C, or Type CAT2) sensing can be performed to start the transmission on the second reserved resource set.

(c) Selection of Resources with RRI Periodic Reservation

In some examples, to select resources with RRI periodic reservation, the interval length of an RRI can be configured to be larger than a duration of forecasted LBT time and gap plus overbooked resource length. In this way, the LBT process between each periodic transmission can have a high chance to succeed.

(4) Solutions for Randomizations in Both LBT Process and Resource Selection

Design principle for random variables in some embodiments is described here. The transmission randomization of SL resource selection may be unnecessary since LBT process already includes a random backoff. If both randomizations of SL resource selection and LBT process are applied, a SL device may suffer from a long latency for transmission. Therefore, in some embodiments, if LBT time is considered in SL-U resource selection (i.e., LBT random backoff is calculated to resize a selection window), then selection of an earliest available resource(s) without randomization can be performed to reduce long self-deferral period of transmission delay.

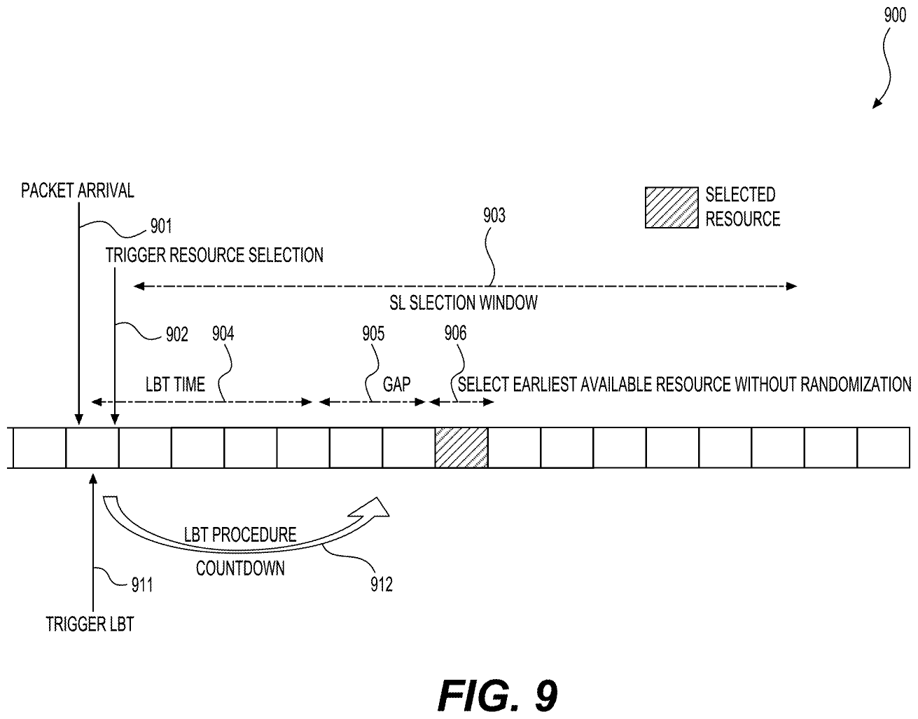

FIG. 9 shows a SL-U channel access process 900 according to some embodiments of the disclosure. In the process 900, an earliest available resource 906 is selected without randomization. Specifically, a resource selection 902 can take place after a packet arrival 901 within a selection window 903. An LBT time 904 and a gap 905 can be predicted. At the end of the duration of the LBT time 904 and the gap 905, the earliest available resource 906 can be selected. Meanwhile, an LBT process (or procedure) 912 including backoff counter countdown can be triggered at the time 911. The LBT trigger timing can be earlier or later than the resource selection 902 in various examples.

(5) Solutions in Case that LBT Completion Time Exceeds the SL Resource Reservation Time

If the LBT countdown process still takes a longer time than expected, the SL transmission slots may expire before the LBT completion. In this case, the following options are adopted in some examples:
Keeping same LBT process and performing SL resource re-selection with similar concepts using LBT time, gap and resource overbooking
Dropping LBT process and re-initiating LBT and SL resource selection

3. Examples of SL-U Channel Access Processes

Several examples of SL-U channel accessed processes based on the techniques and mechanisms disclosed herein are described below. The timing relevance of the following items in the example processes are described:
Packet arrival time of packet of periodic or aperiodic traffic type
LBT process initiation and completion time
SL resource selection time
SL sensing and selection window
Continuous or discontinuous selected resource

Followings are the parameters used for SL resource selection or LBT process.

(a) SL related parameters for resource sensing and selection. FIG. 3 shows the event of SL resource selection and the parameters to define SL sensing window and SL selection window.
n is the resource selection triggering slot
Sensing window slots [n-T0, n-T0proc]
Selection window slots [n+T1, n+T2]

(b) Traffic related parameters.
CAPC channel access priority class to initiate LBT process
QoS
PC5 OoS Identifier (PQI)
Packet transmission deadline to determine SL resource selection window
Packet size to determine LBT requiring COT length and SL selected resource number
Traffic priority to use for SL resource preemption or exclusion

Following are the symbols used in the related figures and the respective definitions:
R=Time of first SL transmission slot
T′=Time of LBT process triggering slot
T=Time of SL available resources starting point
n=Time of SL resource selection triggering slot

The baseline examples can include the following scenario:
Case 1: Device selects continuous resources, and COT acquisition completes successfully
Case 2: Device selects continuous resources, but COT acquisition is failed.
Case 3: Device selects discontinuous resources with multiple COT acquisition.

Case 1: Device Selects Continuous Resources with COT Acquisition Success.

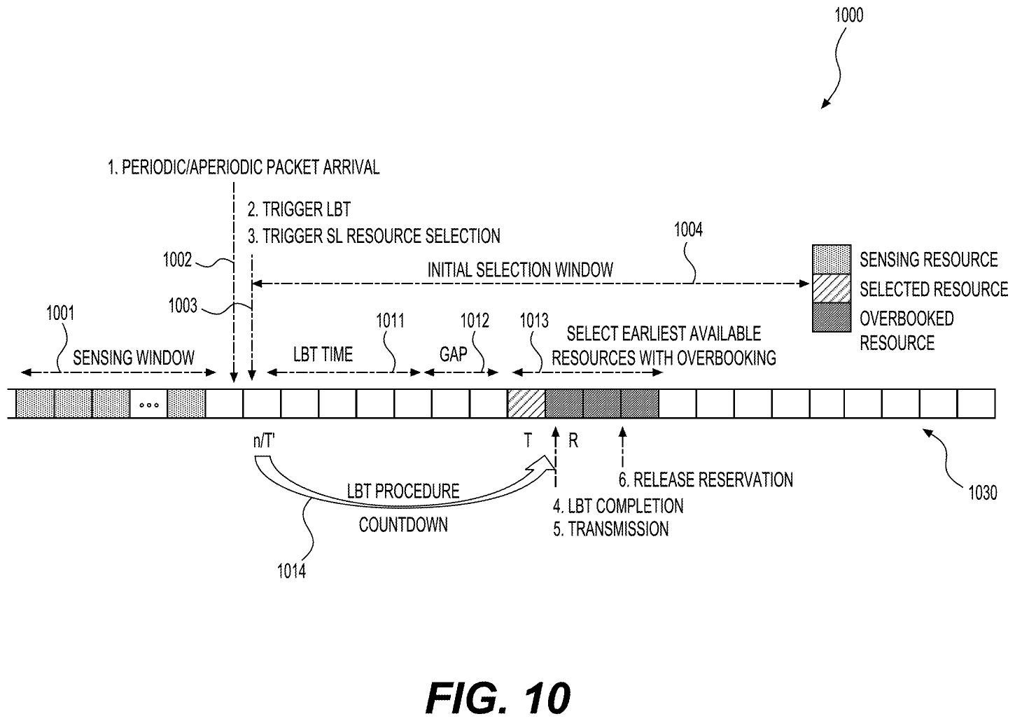

FIG. 10 shows a SL-U channel access process 1000 according to an embodiment of the disclosure. The process 1000 can include the following steps. A sequence of slots 1030 is illustrated for indicating the timings of events taking place during the process 1000.

Step 1. Periodic/Aperiodic Packet Arrival

The process 1000 can be triggered once a new periodic or aperiodic packet arrival takes place at time 1002. At packet arrival, a CAPC for LBT initiation can be obtained. Packet size and packet transmission deadline are available for trigger a SL resource selection. For example, the SL resource selection window 1004 can be ended no later than the packet transmission deadline.

Step 2. Triggering LBT Operation

A Type 1 (or CAT4) LBT process is triggered at time T′ (time 1003, as shown). For example, an LBT counter number is rolled based on a contention window size and thus a backoff window length is determined.

Step 3. Triggering SL Resource Selection Process

A SL resource selection is triggered at the slot n of time 1003 with an initial selection window 1004 [n+T1, n+T2] based on a sensing window 1001 [n-T0, n-T0proc]. Within the selection window 1004, an LBT time 1011 can be calculated first based on the LBT rolled counter number and SL sensing results from the sensing window 1001. Following the LBT time 1011, a flexible margin gap 1012 is added. Then, the starting time, Tw, of a resized selection window is determined according to

Tw=T′+LBT time+Gap

Since LBT process already perform randomization of transmission slots, the SL random selection is unnecessary. In this example, the earliest available resources 1013 (including selected resources and overbooked resources) are selected starting from T (T=Tw) without randomization). (Considering some resources may be reserved by other SL UEs, the timing T of the earliest available resources 1013 may be later than the starting time Tw of the resized resource selection window.) A SL device can select the required resources according to packet size and further select overbooked resources.

In an example, the value (slot numbers) of the gap is a function of a number of overbooked resources (or a function of a number of selected resources and overbooked resources in the FIG. 10 example). In an example, the value (slot numbers) of the gap and a number of overbooked resources follow the expression below:

Gap+Overbooked number of slots=k,

where k is the value determined by pre-configuration or up to system loading.

Step 4. LBT Completion

In the FIG. 10 example, the LBT counter is counted down to zero within the overbooking slots (resources) 1013, then a COT acquisition can be performed directly. As shown, an LBT process (or procedure) countdown 1014 is completed before slot R.

Step 5. Transmission

The SL device can transmit on remaining selected resources within the COT. In the FIG. 10 example, the SL device can perform a first transmission at slot R. A SL resource re-evaluation process can be performed or not performed before the slot R.

Step 6. Release Reservation (Optional)

In some examples, resource cancellation indication may be transmitted by the SL device to release redundant overbooked resources when transmission is finished earlier within overbooked resources.

Case 2: Device Selects Continuous Resources but COT Acquisition is Failed.

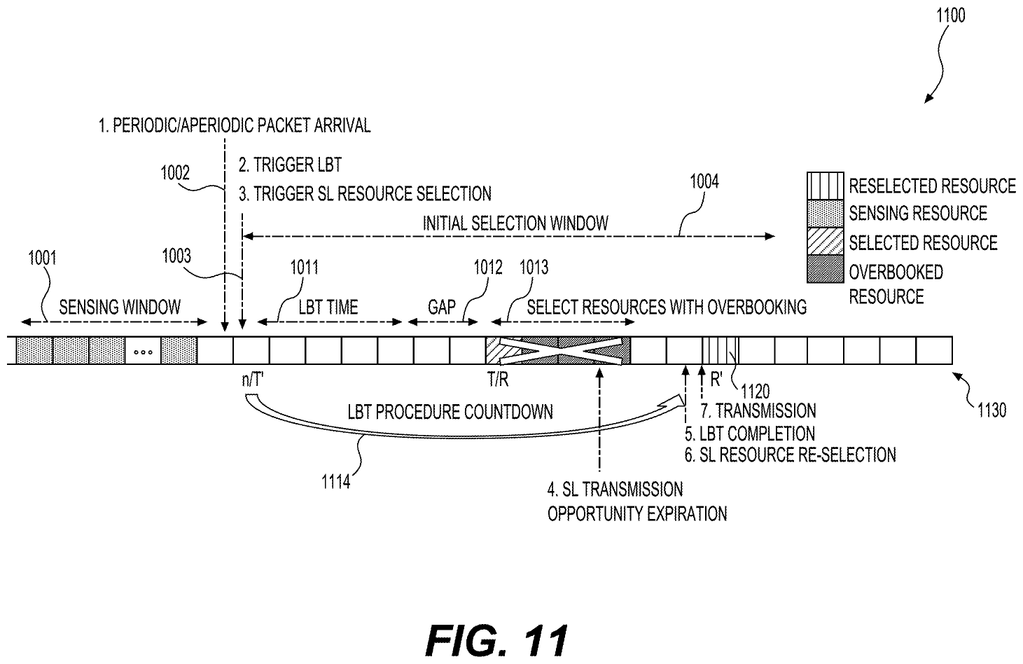

FIG. 11 shows another SL-U channel access process 1100 according to an embodiment of the disclosure. The process 1100 can include the following steps. A sequence of slots 1130 is illustrated for indicating the timings of events taking place during the process 1100.

The steps from 1 to 3 can be similar to the steps from 1 to 3 in Case 1.

Step 4. SL Transmission Opportunity Expiration

As shown, at the latest SL transmission slot among the selected and overbooked resources 1013, an LBT process (procedure) countdown 1114 is not completed yet. Thus, the SL transmission opportunity corresponding to the resources 1013 expires. A SL device can continue the same LBT process and let the backoff counter counts down.

Step 5. LBT Completion

The LBT process completion time of the LBT process countdown exceeds SL transmission slots corresponding to the resources 1013. In an example, the LBT process countdown 1114 is kept with a self-deferral period before a transmission at time R′. Other schemes (such as CPE) may be employed in place of the self-deferral mechanism.

Step 6. SL Resource Reselection

As the previous selected resources 1013 expires, the earliest available resources 1120 at time R′ can be selected as a new transmission resource within a remaining portion of the selection window 1004.

Step 7. Transmission

At the transmission slot of the resource 1120, a short LBT (such as Type 2 LBT or CAT2 LBT) sensing can be performed for COT acquisition. The SL device then transmits onto the reselected resource 1013.

Case 3: Device Selects Discontinuous Resources with Multiple COT Acquisition.

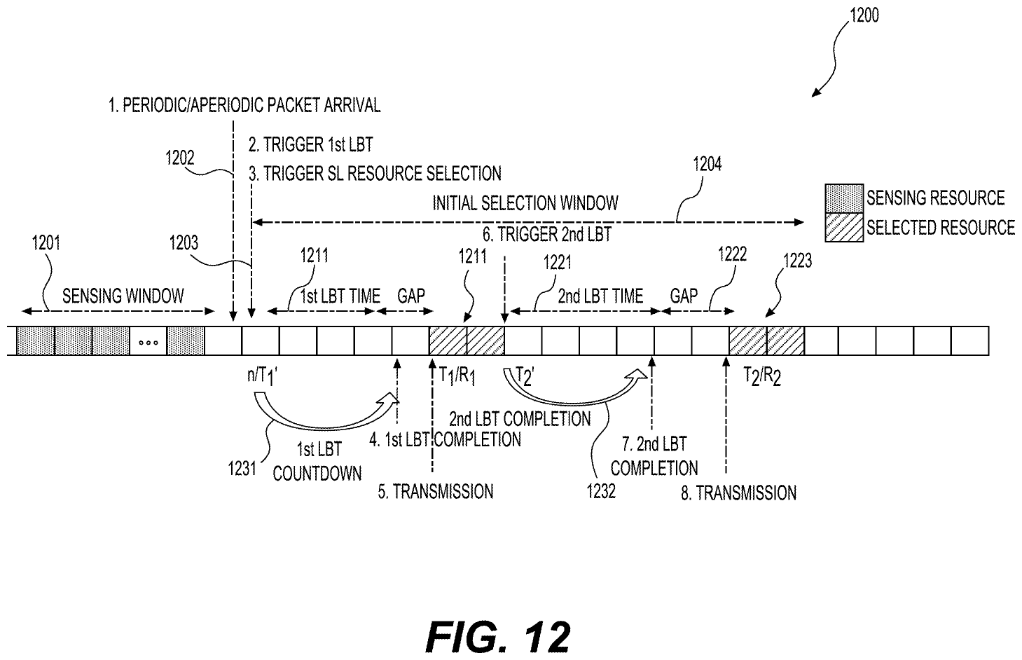

FIG. 12 shows a SL-U channel access process 1200 according to an embodiment of the disclosure. In the process 1200, multiple LBT processes are triggered. Multiple COT acquisitions are performed. The process 1200 can include the following steps.

Step 1. Periodic/Aperiodic Packet Arrival

The process 1200 can be triggered once a new periodic or aperiodic packet arrival takes place at time 1202. At packet arrival, a CAPC for LBT initiation can be obtained. Packet size and packet transmission deadline are available for trigger a SL resource selection. For example, the SL resource selection window 1204 can be ended no later than the packet transmission deadline.

Step 2. Triggering a First LBT Operation

A first Type 1 (or CAT4) LBT countdown process 1231 is triggered at time T′(time 1203, as shown). For example, a first LBT counter number is rolled and thus a first backoff window length is determined.

Step 3. Triggering SL Resource Selection Process

A SL resource selection is triggered at time 1203 with an initial selection window 1201 [n+T1, n+T2] and sensing window 1204 [n-T0, n-T0proc]. A SL device may determine to select two discontinuous resources 1213 and 1223. To select the first resources 1213, a first LBT time 1211 and a first gap 1212 can be predicted. The first resources 1213 can be the earliest available resources after the first gap 1212. To select the second resources 1223, a second LBT time 1221 and a second gap 1222 can be predicted. The second resources 1223 can be the earliest available resources after the second gap 1222.

Since the first LBT countdown process 1231 is initiated before the resource selection, the 1st LBT time 1211 can be calculated from a known LBT counter number. Since a second LBT countdown process 1232 is initiated after the resource selection, a contention window size corresponding to a priority of the arriving packet can be used to calculate the second LBT time 1221.

For example, a time of SL available resources starting points T1 can be determined by

T1=T1′+1st LBT time+Gap.

In some examples, due to resource reservation by other UEs, SL candidate resources may not be available at time T1. In such case, the earliest available candidate resources after T1 can be selected without randomization.

In the FIG. 12 example, the earliest available resources starting from T1 are selected as first resource set 1213. To select second resource set 1223, T2′ and T2 is determined as follows:
T2′=End time of first selected resource set 1213
T2=T2′+2nd LBT time+Gap
   Again, the earliest available resources starting from T2 are selected to be second resource set 1223.

Step 4. First LBT Completion

The first LBT countdown process 1231 can be performed. A first self-deferral period can be performed after the first LBT countdown process 1231 completion before the reserved transmission slots of the resources 1213.

Step 5. First Transmission

The SL device transmits on selected resources 1213 within a first COT. For example, a short LBT can be performed at the end of the first self-deferral period. When the channel is idle, the first COT can be obtained.

Step 6. Triggering a Second LBT Operation

When the first COT ends, a second Type 1 LBT countdown process 1232 can be triggered at time T2′.

Step 7. Second LBT Completion

The second LBT countdown process 1232 can be performed. A second self-deferral period can be performed after the second LBT countdown process 1232 completion before the reserved transmission slots of the resources 1223.

Step 8. Second Transmission

The SL device transmits on selected resources 1214 within a second COT. For example, a short LBT can be performed at the end of the second self-deferral period. When the channel is idle, the second first COT can be obtained.

V. Further Examples of SL-U Access Processes

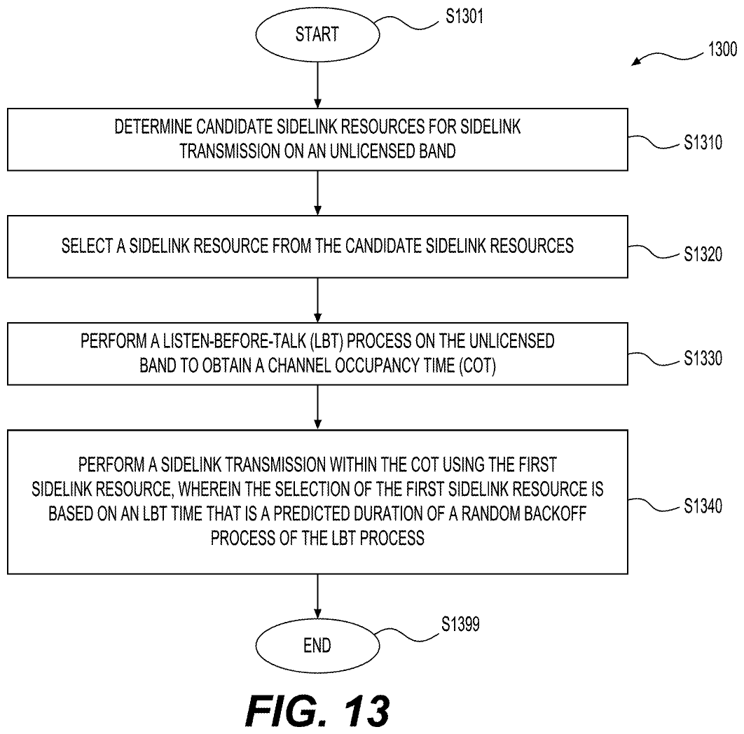

FIG. 13 shows a SL-U channel access process 1300 according to embodiments of the disclosure. The process 1300 can be performed by a UE. The process 1300 can start from S1310. It is noted that examples of processes (or procedures) disclosed herein can include multiple steps. In various embodiments, those steps can be performed in an order different from what is described in the examples. Also, not all of those steps are performed. In some embodiments, those steps may be performed in parallel.

At S1310, candidate sidelink resources can be determined by the UE for sidelink transmission on an unlicensed band. The candidate sidelink resources can be determined from a sidelink resource selection window based on results of a sensing operation on the unlicensed band during a sidelink sensing window.

At S1320, a sidelink resource can be selected from the candidate sidelink resources. In an example, in response to an LBT counter of the random backoff process being known, an LBT time is determined to be a sum of a minimum LBT completion duration determined based on a value of the LBT counter and a duration of busy slots determined based on the results of the sensing operation. In an example, in response to the LBT counter of the random backoff process being unknown, the LBT time can be determined to be a sum of a maximum LBT completion duration determined based on a size of a contention window and the duration of the busy slots determined based on the results of the sensing operation.

In an example, a predicted completion duration of the random backoff process can be determined to be a sum of the LBT time and a gap that is pre-configured or determined based on a system loading. In an example, sidelink resources are overbooked from the candidate sidelink resources. In an example, a predicted LBT completion duration of the random backoff process is determined to be a sum of the LBT time and a gap. For example, the gap can be configured as a function of the number of overbooked sidelink resources.

In an example, multiple consecutive slots of sidelink resources are selected from the candidate sidelink resources. In an example, two discontinuous sidelink resources are selected from the candidate sidelink resources. In an example, multiple sidelink resources with a resource reservation interval (RRI) are selected.

At S1330, an LBT process can be performed on the unlicensed band to obtain a COT. In an example, the selection of the first sidelink resource from the candidate sidelink resources is triggered before the LBT process. In an example, the selection of the first sidelink resource from the candidate sidelink resources is triggered before a completion of the first LBT process. In an example, the selection of the first sidelink resource from the candidate sidelink resources is triggered after the first LBT process.

At S1340, a sidelink transmission can be performed within the COT using the sidelink resource selected at S1320. In an embodiment, the selection of the first sidelink resource is based on the LBT time. The process 1300 can proceed to S1399 and terminate at S1399.

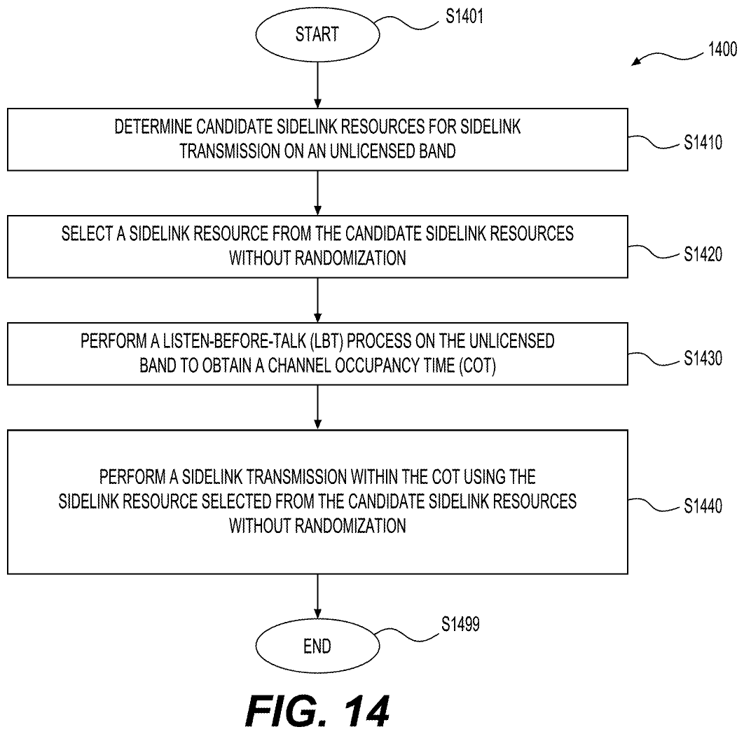

FIG. 14 shows another SL-U channel access process 1400 according to embodiments of the disclosure. The process 1400 can be performed by a UE. The process 1400 can start from S1410.

At S1410, candidate sidelink resources can be determined for sidelink transmission on an unlicensed band. The candidate sidelink resources can be determined from a sidelink resource selection window based on results of a sensing operation on the unlicensed band during a sidelink sensing window.

At S1420, a sidelink resource can be selected from the candidate sidelink resources without randomization. In an example, a completion time of a random backoff process of the LBT process can be predicted. Accordingly, an earliest available resource can be selected from the candidate sidelink resources based on the completion time of the random backoff process of the LBT process. In an example, a resized sidelink resource selection window can be determined based on the completion time of the random backoff process. The candidate sidelink resources can be determined from the resized sidelink resource selection window. In an example, an earliest available resource can be selected from the candidate sidelink resources without randomization after a completion of a random backoff process of the LBT process. In a further example, multiple consecutive slots of sidelink resources are overbooked from the candidate sidelink resources.

At S1430, an LBT process can be performed on the unlicensed band to obtain a COT. In an example, at an end of a random backoff process of the LBT process, a self-deferral operation can be performed followed by a short LBT sensing process before the sidelink transmission using the first sidelink resource. The COT can be obtained when a channel of the unlicensed band is idle during the short LBT sending process. In an example, the COT can be obtained immediately after a completion of a random backoff process of the LBT process. A short LBT sensing process can be obtained before the sidelink transmission using the first sidelink resource.

At S1440, a sidelink transmission can be performed within the COT using the sidelink resource selected from the candidate sidelink resources without randomization. In an example, a cyclic prefix (CP) transmission can be performed between a completion time of a random backoff process of the LBT process and a slot containing the first sidelink resource to occupy the unlicensed band. The process 1400 can proceed to S1499 and terminate at S1499.

VI. Apparatus and Non-Transitory Computer-Readable Medium

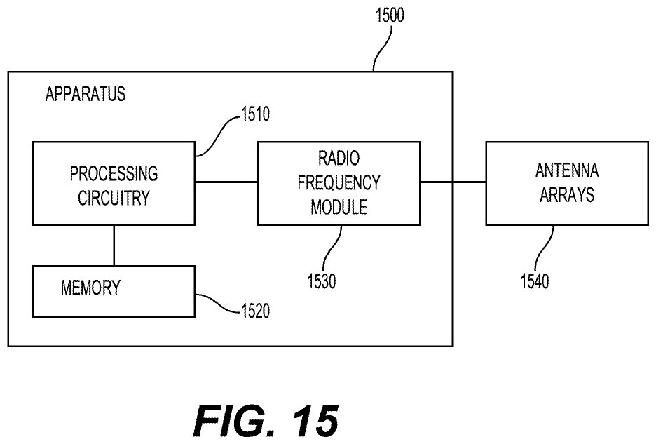

FIG. 15 shows an exemplary apparatus 1500 according to embodiments of the disclosure. The apparatus 1500 can be configured to perform various functions in accordance with one or more embodiments or examples described herein. Thus, the apparatus 1500 can provide means for implementation of mechanisms, techniques, processes, functions, components, systems described herein. For example, the apparatus 1500 can be used to implement functions of UEs or BSs in various embodiments and examples described herein. The apparatus 1500 can include a general-purpose processor or specially designed circuits to implement various functions, components, or processes described herein in various embodiments. The apparatus 1500 can include processing circuitry 1510, a memory 1520, and a radio frequency (RF) module 1530.

In various examples, the processing circuitry 1510 can include circuitry configured to perform the functions and processes described herein in combination with software or without software. In various examples, the processing circuitry 1510 can be a digital signal processor (DSP), an application specific integrated circuit (ASIC), programmable logic devices (PLDs), field programmable gate arrays (FPGAs), digitally enhanced circuits, or comparable device or a combination thereof.

In some other examples, the processing circuitry 1510 can be a central processing unit (CPU) configured to execute program instructions to perform various functions and processes described herein. Accordingly, the memory 1520 can be configured to store program instructions. The processing circuitry 1510, when executing the program instructions, can perform the functions and processes. The memory 1520 can further store other programs or data, such as operating systems, application programs, and the like. The memory 1520 can include non-transitory storage media, such as a read only memory (ROM), a random access memory (RAM), a flash memory, a solid state memory, a hard disk drive, an optical disk drive, and the like.

In an embodiment, the RF module 1530 receives a processed data signal from the processing circuitry 1510 and converts the data signal to beamforming wireless signals that are then transmitted via antenna arrays 1540, or vice versa. The RF module 1530 can include a digital to analog converter (DAC), an analog to digital converter (ADC), a frequency up converter, a frequency down converter, filters and amplifiers for reception and transmission operations. The RF module 1530 can include multi-antenna circuitry for beamforming operations. For example, the multi-antenna circuitry can include an uplink spatial filter circuit, and a downlink spatial filter circuit for shifting analog signal phases or scaling analog signal amplitudes. The antenna arrays 1540 can include one or more antenna arrays.

The apparatus 1500 can optionally include other components, such as input and output devices, additional or signal processing circuitry, and the like. Accordingly, the apparatus 1500 may be capable of performing other additional functions, such as executing application programs, and processing alternative communication protocols.

The processes and functions described herein can be implemented as a computer program which, when executed by one or more processors, can cause the one or more processors to perform the respective processes and functions. The computer program may be stored or distributed on a suitable medium, such as an optical storage medium or a solid-state medium supplied together with, or as part of, other hardware. The computer program may also be distributed in other forms, such as via the Internet or other wired or wireless telecommunication systems. For example, the computer program can be obtained and loaded into an apparatus, including obtaining the computer program through physical medium or distributed system, including, for example, from a server connected to the Internet.

The computer program may be accessible from a computer-readable medium providing program instructions for use by or in connection with a computer or any instruction execution system. The computer readable medium may include any apparatus that stores, communicates, propagates, or transports the computer program for use by or in connection with an instruction execution system, apparatus, or device. The computer-readable medium can be magnetic, optical, electronic, electromagnetic, infrared, or semiconductor system (or apparatus or device) or a propagation medium. The computer-readable medium may include a computer-readable non-transitory storage medium such as a semiconductor or solid-state memory, magnetic tape, a removable computer diskette, a random access memory (RAM), a read-only memory (ROM), a magnetic disk and an optical disk, and the like. The computer-readable non-transitory storage medium can include all types of computer readable medium, including magnetic storage medium, optical storage medium, flash medium, and solid state storage medium.

While aspects of the present disclosure have been described in conjunction with the specific embodiments thereof that are proposed as examples, alternatives, modifications, and variations to the examples may be made. Accordingly, embodiments as set forth herein are intended to be illustrative and not limiting. There are changes that may be made without departing from the scope of the claims set forth below.

What is claimed is:

1. A method, comprising:
determining, by a user equipment (UE), candidate sidelink resources for sidelink transmission on an unlicensed band from a sidelink resource selection window based on results of a sensing operation on the unlicensed band during a sidelink sensing window;
selecting a first sidelink resource from the candidate sidelink resources without randomization;
performing a listen-before-talk (LBT) process on the unlicensed band to obtain a channel occupancy time (COT); and
performing a sidelink transmission within the COT using the first sidelink resource selected from the candidate sidelink resources without randomization.

2. The method of claim 1, wherein the selecting comprises:
predicting a completion time of a random backoff process of the LBT process; and
selecting an earliest available resource from the candidate sidelink resources to be the first sidelink resource based on the completion time of the random backoff process of the LBT process.

3. The method of claim 1, wherein the selecting comprises:
after a completion of a random backoff process of the LBT process, selecting an earliest available resource from the candidate sidelink resources without randomization.

4. The method of claim 1, further comprising:
in response to that a completion time of a random backoff process of the LBT process is later than a reservation time of the first sidelink resource,
continuing the LBT process;
predicting a completion time of a random backoff process of the LBT process; and
reselecting an earliest available resource from a set of candidate sidelink resources without randomization to be a second sidelink resource based on the completion time of the random backoff process of the LBT process.

5. The method of claim 1, further comprising:
in response to that a completion time of a random backoff process of the LBT process is later than a reservation time of the first sidelink resource,
dropping the LBT process, and
re-initiating another LBT process and selection of another sidelink resource.

6. The method of claim 1, wherein the performing the LBT process comprises:
at an end of a random backoff process of the LBT process, performing a self-deferral operation followed by a short LBT sensing process before the sidelink transmission using the first sidelink resource; and
obtaining the COT when a channel of the unlicensed band is idle during the short LBT sending process.

7. The method of claim 1, wherein the performing the LBT process comprises:
obtaining the COT after a completion of a random backoff process of the LBT process; and
performing a short LBT sensing process before the sidelink transmission using the first sidelink resource.

8. The method of claim 1, further comprising:
performing transmission on a cyclic prefix extension (CPE) starting position between a completion time of a random backoff process of the LBT process and a slot containing the first sidelink resource to occupy the unlicensed band.

9. The method of claim 1, wherein the selecting comprises:
overbooking multiple consecutive slots of sidelink resources from the candidate sidelink resources.

10. The method of claim 1, further comprising:
receiving data corresponding a periodic traffic or an aperiodic traffic at a physical layer, wherein the data is transmitted by the sidelink transmission within the COT using the first sidelink resource.

11. The method of claim 1, wherein the LBT process is triggered when a channel access priority class of a to-be-transmitted packet is available.

12. An apparatus, comprising circuitry configured to:
determine candidate sidelink resources for sidelink transmission on an unlicensed band from a sidelink resource selection window based on results of a sensing operation on the unlicensed band during a sidelink sensing window;
select a first sidelink resource from the candidate sidelink resources without randomization;
perform a listen-before-talk (LBT) process on the unlicensed band to obtain a channel occupancy time (COT); and
perform a sidelink transmission within the COT using the first sidelink resource selected from the candidate sidelink resources without randomization.

13. The apparatus of claim 12, wherein the circuitry is further configured to:
predict a completion time of a random backoff process of the LBT process; and
select an earliest available resource from the candidate sidelink resources to be the first sidelink resource based on the completion time of the random backoff process of the LBT process.

14. The apparatus of claim 12, wherein the circuitry is further configured to:
after a completion of a random backoff process of the LBT process, select an earliest available resource from the candidate sidelink resources without randomization.

15. The apparatus of claim 12, wherein the circuitry is further configured to:
in response to that a completion time of a random backoff process of the LBT process is later than a reservation time of the first sidelink resource,
continue the LBT process;
predict a completion time of a random backoff process of the LBT process; and
reselect an earliest available resource from a set of candidate sidelink resources without randomization to be a second sidelink resource based on the completion time of the random backoff process of the LBT process.

16. The apparatus of claim 12, wherein the circuitry is further configured to:
in response to that a completion time of a random backoff process of the LBT process is later than a reservation time of the first sidelink resource,
drop the LBT process, and
re-initiate another LBT process and selection of another sidelink resource.

17. The apparatus of claim 12, wherein the circuitry is further configured to:
at an end of a random backoff process of the LBT process, perform a self-deferral operation followed by a short LBT sensing process before the sidelink transmission using the first sidelink resource; and
obtain the COT when a channel of the unlicensed band is idle during the short LBT sending process.

18. The apparatus of claim 12, wherein the circuitry is further configured to:
obtain the COT after a completion of a random backoff process of the LBT process; and
perform a short LBT sensing process before the sidelink transmission using the first sidelink resource.

19. The apparatus of claim 12, wherein the circuitry is further configured to:
perform transmission on a cyclic prefix extension (CPE) starting position between a completion time of a random backoff process of the LBT process and a slot containing the first sidelink resource to occupy the unlicensed band.

20. A non-transitory computer-readable medium storing instructions that, when executed by a processor, cause the processor to perform a method, the method comprising determining candidate sidelink resources for sidelink transmission on an unlicensed band from a sidelink resource selection window based on results of a sensing operation on the unlicensed band during a sidelink sensing window;
selecting a first sidelink resource from the candidate sidelink resources without randomization;
performing a listen-before-talk (LBT) process on the unlicensed band to obtain a channel occupancy time (COT); and
performing a sidelink transmission within the COT using the first sidelink resource selected from the candidate sidelink resources without randomization.
